(19) United States
(12) Patent Application Publication
(10) Pub. No.: US 2020/0086692 A1
(43) Pub. Date: Mar. 19, 2020

(54) TIRE RESISTANT TO CHEMICAL ATTACK

(71) Applicant: COMPAGNIE GENERALE DES ETABLISSEMENTS MICHELIN, Clermont-Ferrand (FR)

(72) Inventors: JOSE MERINO LOPEZ, Clermont-Ferrand (FR); PIERRE WIEL, Clermont-Ferrand (FR)

(21) Appl. No.: 16/471,225

(22) PCT Filed: Dec. 19, 2017
(86) PCT No.: PCT/FR2017/053676

§ 371 Date: Jun. 19, 2019

(30) Foreign Application Priority Data
Dec. 20, 2016 (FR) 1662894

(51) Int. Cl. B60C 13/02

(52) U.S. Cl. CPC B60C 13/02

(57) ABSTRACT

A tire for a rolling assembly comprises a rim and a tire, said tire having at least one carcass reinforcement (2) surmounted radially on the outside by a crown reinforcement (3), itself radially on the inside of a tread (4) having two axially outermost ends, said crown reinforcement (3) being made up of at least one layer of reinforcing elements, said tread (4) being connected to two beads (5) by way of two sidewalls (6), said beads (5) being intended to come into contact with a rim (7) having rim flange tops (7a), each bead (5) having at least one circumferential reinforcing element. Each sidewall (6) comprises at least one set (10) of sipes (11) that are substantially parallel and spaced apart at a spacing (Ps) having a value strictly less than 5 mm, each sipe (11) being formed in the sidewall (6) with a depth (H) and a width (e), the depth (H) having a value of between one quarter of the value of said spacing (Ps) and the value of said spacing (Ps), and the width (e) having a value strictly less than one quarter of said spacing (Ps).

### FIELD OF THE INVENTION

The invention relates to cross-ply or radial-carcass tyres.

### PRIOR ART

Radial-carcass tyres have gradually become established in various markets, notably the market for passenger vehicle tyres. This success is due in particular to the endurance, comfort and low rolling resistance qualities that radial tyres have to offer.

The main parts of a tyre are the tread, the sidewalls and the beads. The beads are intended to come into contact with the rim. In a radial tyre, each of the main parts of which the tyre is made, namely the tread, the sidewalls and the beads, has functions that are clearly separated from one another, and therefore has a well-known specific makeup.

A radial tyre is essentially reinforced by a carcass reinforcement comprising at least one carcass ply set at an angle substantially equal to 90° with respect to the circumferential direction of the tyre. This carcass reinforcement is surmounted radially on the outside, and under the tread, by reinforcing plies that form a belt.

A cross-ply tyre differs from a radial tyre in that there are at least two crossed plies set at angles other than 90° with respect to the circumferential direction of the tyre. The plies are said to be “crossed” because the angles are of opposite sign from one ply to the next.

It will be recalled that, according to the invention, the circumferential direction of the tyre is the direction in a plane perpendicular to the axis of rotation of the tyre and tangential to the tyre belt reinforcement.

Since the emergence of radial-carcass tyres, certain cross-ply tyres have also been provided with a belt reinforcement under the tread.

In both these types of tyre, the tread, in direct contact with the ground, notably has the function of providing contact with the roadway and needs to adapt to the shape of the ground. The sidewalls for their part absorb the unevennesses of the ground while transmitting the mechanical forces required to support the load of the vehicle and allow it to move.

The belt reinforcement is a reinforcement which, on the one hand, needs to be sufficiently rigid with regard to edge deformations so that the tyre can develop the cornering thrust necessary for steering, and transmit torque for traction or for braking and, on the other hand, be very soft in bending, that is to say allow variations in curvature in its plane in order to provide a sufficient area of contact of the tyre with the ground.

As a result, the belt reinforcement generally has a composite structure allowing it to offer the required rigidity for a relatively low weight. The belt reinforcement is generally made up of at least two plies set at different angles, comprising reinforcers, in the form of cords, coated with rubber. The reinforcing elements are crossed from one ply to the next with respect to the circumferential direction.

A tyre is subjected to different types of attack on its surface, in particular physical attacks caused by impacts, for example, for the sidewalls of the tyre, impacts with kerbs or in potholes.

However, there exist other attacks, this time of the chemical type, for example the action of ozone on the tyre.

Specifically, the action of ozone on the tyre encourages the appearance of surface cracks. These cracks are a sign of ageing and of a lack of robustness of the tyre, and they are a source of concern for the user client.

There is a need for a tyre that is robust, in particular at the sidewall, being resistant to ozone attack throughout the service life of the tyre.

In order to reduce the effect of these chemical attacks, solutions exist that consist in chemically protecting the material of which the tyre is made. For example, the use of waxes in the mixture has been proposed, these waxes migrating towards the surface of the tyre and creating a protective layer. Another solution consists in using antioxidants in the mixture, such as 6PPD. However, cracks appear in spite of the application of these protective measures. Moreover, the use of waxes can bring about a lighter colouration of the sidewall, possibly causing stains if the colouration is not uniform, this not being desired for the visual appearance of the tyre.

Therefore, it is an aim of the present invention to propose a tyre that has increased resistance to chemical surface attacks, notably at the sidewalls, and does not have the drawbacks of the prior art.

In particular, an aim of the present invention is to propose a tyre that is resistant to chemical attacks, notably to ozone attacks, at the sidewalls of said tyre, without it being necessary to modify the composition of the material forming the tyre.

### SUMMARY OF THE INVENTION

To this end, a tyre for a rolling assembly comprising a rim and a tyre is proposed, said tyre having at least one carcass reinforcement surmounted radially on the outside by a crown reinforcement, itself radially on the inside of a tread having two axially outermost ends, said crown reinforcement being made up of at least one layer of reinforcing elements, said tread being connected to two beads by way of two sidewalls, said beads being intended to come into contact with a rim having rim flange tops, each bead having at least one circumferential reinforcing element, wherein each sidewall comprises at least one set of sipes that are substantially parallel and spaced apart at a spacing (Ps) having a value strictly less than 5 mm, each sipe being formed in the sidewall with a depth (H) and a width (e), the depth (H) having a value of between one quarter of the value of said spacing (Ps) and the value of said spacing (Ps), and the width (e) having a value strictly less than one quarter of said spacing (Ps).

Preferred but non-limiting aspects of this tyre, taken individually or in combination, are the following:
each sipe has a depth (H) having a value of between one third of the value of said spacing (Ps) and seven tenths of the value of said spacing (Ps).
the spacing (Ps) has a value strictly less than 3.5 mm.
each sipe has a width (e) having a value strictly less than one tenth of said spacing (Ps), preferably strictly less than one tenth of a quarter of said spacing (Ps).
each sipe has a width (e) having a value strictly less than 0.45 mm.
each sipe has a width (e) having a value less than or equal to 0.3 mm, preferably less than or equal to 0.2 mm.
each sipe has a cross section having a straight portion of width (e) and extending from the surface of said sidewall, and a circular portion extending from the straight portion, said circular portion having a radius (r) having a value strictly greater than two thirds of the value of the width (e).
the sipes are arranged over the entire area of the sidewall.
the sipes are arranged in a region of the sidewall contained at least between a point A and a point C, and preferably only in this region, where:
   the point A is positioned at the junction between the sidewall and the tread;
   the point C is positioned on the sidewall where the distance between the two sidewalls of the tyre is greatest when the tyre is inflated.
each sipe extends generally in a longitudinal direction (D_{L}).
the sipes are formed on the sidewall in a longitudinal direction (D_{L}) so as form an angle α of between 0° and 60°, preferably an angle α equal to 45°, with the circumferential direction (D_{C}) of the tyre.
each sidewall comprises a second set of sipes, wherein the sipes of the second set form an angle β with the sipes of the set, the angle β being between 70° and 120°, preferably between 80° and 110°, and more preferably equal to 90°.
the sipes of the second set have a shape and/or relative arrangement identical to those of the sipes of the set.
the sidewall comprises at least one portion protruding with respect to the surface of said sidewall, the sidewall comprising at least one complementary sipe delimiting said protruding portion.
the complementary sipe is formed at the corner edge between the protruding portion and the surface of the sidewall.
the complementary sipe has a shape identical to that of the sipes of the set.

### DESCRIPTION OF THE FIGURES

Further features and advantages of the invention will become more apparent from the following description, which is purely illustrative and non-limiting and should be read in conjunction with the appended drawings, in which:

FIG. 1 schematically shows the cross section of a tyre on a radial plane;

FIG. 2 shows a view in cross section of the sidewall of a tyre in which there are formed sipes according to a first embodiment of the invention;

FIG. 3 shows a view in cross section of the sidewall of a tyre in which there are formed sipes according to a second embodiment of the invention;

FIG. 4 schematically shows a side view of a tyre sidewall having an arrangement of sipes according to a first embodiment;

FIG. 5 schematically shows a side view of a tyre sidewall having an arrangement of sipes according to a second embodiment;

FIG. 6 schematically shows a side view of a tyre sidewall having an arrangement of sipes according to a third embodiment,

FIG. 7 shows a side view of a tyre sidewall having sipes formed around the marking of said tyre sidewall;

FIG. 8 is a graph highlighting the ozone resistance of the tyres according to the invention compared with standard tyres.

### DETAILED DESCRIPTION OF THE INVENTION

In this document, the “tread surface” is understood to be all of the points of the tread of a tyre that are likely to come into contact with the ground when the tyre is being driven on.

When using the term “radial”, a distinction should be made between several different uses of the word by a person skilled in the art.

Firstly, the expression refers to a radius of the tyre. A “radial direction” is a direction that intersects the axis of rotation of the tyre and is perpendicular thereto. It is within this meaning that a point P1 is said to be “radially inside” a point P2 (or “radially on the inside” of the point P2) if it is closer to the axis of rotation of the tyre than the point P2. Conversely, a point P3 is said to be “radially outside” a point P4 (or “radially on the outside” of the point P4) if it is further away from the axis of rotation of the tyre than the point P4. Progress will be said to be “radially inwards (or outwards)” when it is in the direction of smaller (or larger) radii. It is this sense of the word that applies also when radial distances are being discussed. Furthermore, the radius Rx of a point X of the tyre is the radial distance between the axis of rotation of said tyre and the point X.

On the other hand, a thread or a reinforcement is said to be “radial” when the thread or the reinforcing elements of the reinforcement make an angle greater than or equal to 80° and less than or equal to 90° with the circumferential direction. Let us specify that, in this document, the term “thread” should be understood in a very general sense and comprises threads in the form of monofilaments, multifilaments, a cord, a folded yarn or an equivalent assembly, irrespective of the material of which the thread is made or of the surface treatment it has received in order to encourage it to bond with the rubber.

Finally, a “radial cross section” or “radial section” means here a cross section or a section in a plane which contains the axis of rotation of the tyre. A “radial or meridian plane” is a plane which contains the axis of rotation of the tyre.

An “axial” direction is a direction parallel to the axis of rotation of the tyre. A point P5 is said to be “axially inside” a point P6 (or “axially on the inside” of the point P6) if it is closer to the median plane of the tyre than the point P6. Conversely, a point P7 is said to be “axially outside” a point P8 (or “axially on the outside” of the point P8) if it is further away from the median plane of the tyre than the point P8.

The “median plane or equatorial plane” of the tyre is the plane which is perpendicular to the axis of rotation of the tyre and which lies at equal distances from the annular reinforcing structures of each bead. This plane divides the tyre into two substantially equal halves, that is to say passes through the middle of the tread.

A “circumferential direction” is a direction which is perpendicular both to a radius of the tyre and to the axial direction. This corresponds to the running direction of the tyre.

A “circumferential cross section” or “circumferential section” is in each case a cross section or a section in a plane perpendicular to the axis of rotation of the tyre. A “circumferential plane” is a plane perpendicular to the axis of rotation of the tyre.

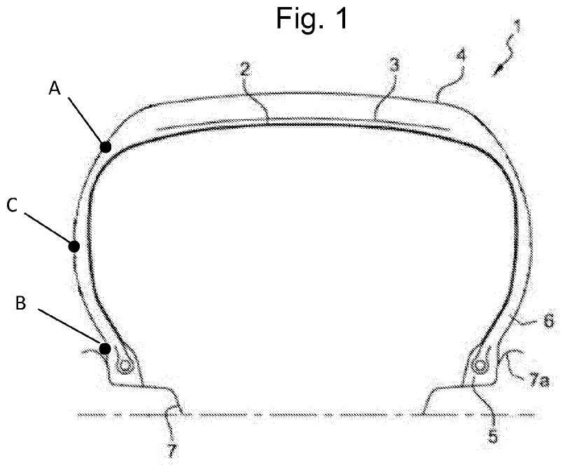

FIG. 1 shows the cross section of a tyre 1 on a radial plane.

In a conventional manner, the tyre 1 comprises at least one carcass reinforcement 2, surmounted radially on the outside by a crown reinforcement 3, itself radially on the inside of a tread 4 having two axially outermost ends.

The crown reinforcement 3 is made up of at least one layer of reinforcing elements, and generally of several reinforcing layers.

The tread 4 is connected to two beads 5 by way of two sidewalls 6.

The beads 5 are intended to come into contact with a rim 7 having rim flange tops 7a. Each bead 5 preferably comprises at least one circumferential reinforcing element.

It has been found that the surface stresses that exist at the sidewalls 6 of the tyre encourage breaks or deterioration in general of said sidewall that are caused by chemical attacks. Ozone in particular acts in these stressed regions of the sidewall 6 and not only encourages the appearance of breaks in the surface of the material forming the sidewall 6 but also the propagation of these breaks.

The proposal here is to form cuts in the surface of the sidewall 6 so as to form sipes intended to reduce the mechanical stresses in the region of the sidewall, thereby limiting the harmful action of ozone.

More specifically, the proposal is to form sipes that are dense and not very deep. Thus, at least one of the sidewalls 6 of the tyre 1, and preferably both sidewalls 6 of the tyre 1, comprises at least one set 10 of sipes 11 that are substantially parallel, where two adjacent sipes are spaced apart at a spacing Ps.

Preferably, the spacing Ps between the sipes 11 of the set 10 of sipes is constant.

However, it is possible for the spacing Ps between two adjacent sipes 11 to be variable over the set 10 of sipes. For example, it is possible for the set 10 of sipes to comprise several subsets of sipes with different spacings Ps, the spacing Ps being constant within the subset in question, however.

A given sipe 11 is defined with respect to the spacing Ps separating it from the adjacent sipe.

As indicated above, the sipes 11 are relatively dense on the sidewall, and therefore the spacing Ps preferably has a value strictly less than 5 mm. More preferably, the spacing Ps of the sipes 11 has a value strictly less than 3.5 mm.

Preferably, each sipe 11 of the set 10 of sipes extends generally in a longitudinal direction D_{L}. A sipe 11 may also have a substantially longitudinal shape, the sipe extending for example along a straight or curved line.

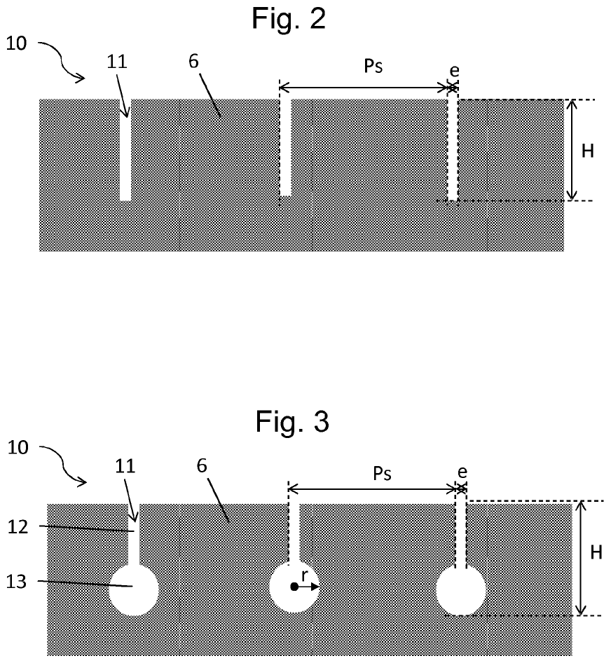

Each sipe 11 formed in the sidewall 6 may be characterized by a depth H and a width e as illustrated in FIGS. 2 and 3.

The depth H chosen for the sipe depends on the spacing Ps provided between two sipes 11 of the set 10.

The sipes 11 are thus preferably formed with a height H having a value of between one quarter of the value of said spacing Ps and the value of said spacing Ps, namely:

1/4Ps<H<Ps

More preferably, each sipe 11 has a depth H having a value of between on third of the value of said spacing (P) and seven tenths of the value of said spacing Ps, namely:

1/3Ps<H<0.7Ps

The width e of the sipe 11 is also preferably chosen depending on the spacing Ps of the set 10 of sipes 11.

Preferably, the width e has a value strictly less than one tenth of said spacing Ps, namely:

e<0.1Ps

According to a preferred embodiment, each sipe 11 has a width e having a value strictly less than 0.45 mm.

According to another embodiment, each sipe 11 has a width e having a value less than or equal to 0.3 mm, and preferably less than or equal to 0.2 mm.

The shape of the sipes 11 may be more or less complex, and is generally chosen so as to reduce the stresses on the sidewall 6 as much as possible and also depends on the envisaged dimensions of said sipe 11, and vice versa.

According to the example shown in FIG. 2, each sipe 11 has a simple, elongate cut shape, i.e. the sipe 11 has a cross section having a single straight portion.

In the example in FIG. 2, the straight portion has a squared-off end, but it may also be conceivable to make a sipe 11 with a straight portion having a rounded end, this allowing better absorption of rolling stresses.

Also preferably, to minimize the rolling stresses at the bottom of the sipes 11, sipes having a profile as illustrated in FIG. 3 are provided.

In this example, each sipe 11 has a cross section having a first, straight portion 12 of width e and extending from the surface of said sidewall 6. This first, straight portion 12 is continued towards the bottom of the sipe by a second, substantially circular portion 13.

The circular portion 13 of the sipe 11 in FIG. 3 preferably has a radius r having a value strictly greater than half the value of the width e (r>1/2e), and preferably a value strictly greater than two thirds of the value of the width e (r>2/3e).

The radius r of this second, circular portion 13 preferably has a value greater than or equal to 0.3 mm.

The presence of a circular portion, or more generally of a second portion comprising a rounded part, with a diameter greater than the width of the straight part, in the form of a slit, is particularly advantageous for ensuring the endurance of the tyre.

The sipes 11 may be arranged over the entire area of the sidewall 6, that is to say between a point A and a point B, where:
the point A is positioned at the junction between the sidewall 6 and the tread 4; the point A is preferably at an axially outermost end of the tread 4.
the point B is positioned at the edge of the rim flange 7a.

However, as illustrated in FIG. 1, these sipes 11 are preferably formed over a smaller portion of the sidewall 6, in particular in a region of the sidewall 6 contained between the point A and a point C, where the point C is positioned on the sidewall 6 where the distance between the two sidewalls 6 of the tyre is greatest when the tyre is inflated. The point C corresponds to the region of the sidewall commonly referred to as the “equator”.

The sipes may be formed in a region of the sidewall 6 contained at least between the point A and the point C, that is to say they can extend beyond the point C, in the direction of the point B positioned at the edge of the rim flange 7a.

The sipes 11 of the set 10 can have various orientations on the sidewall 6.

Preferably, the sipes 11 extending generally in a longitudinal direction D_{L} are formed on the sidewall 6 such that their longitudinal axis D_{L} forms an angle α of between 0° and 60° with the circumferential direction D_{C} of the tyre 1.

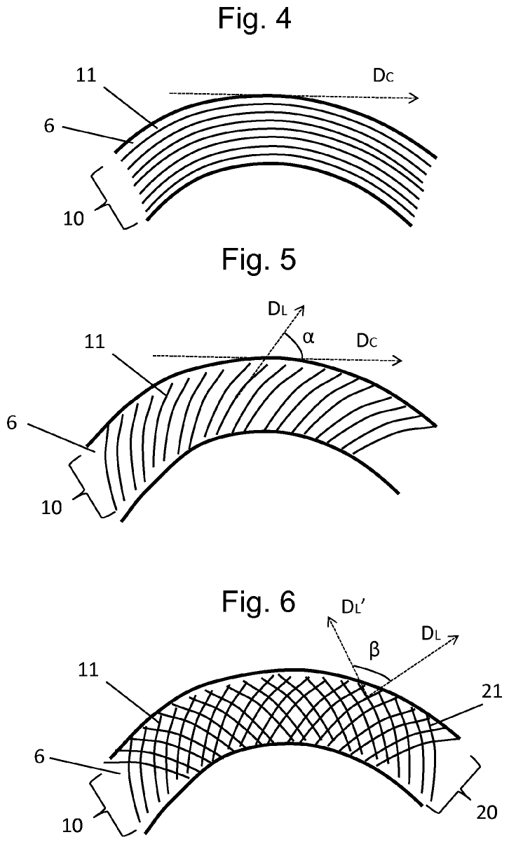

In the example in FIG. 4, the sipes 11 are formed in the circumferential direction D_{C} of the tyre 1, i.e. the angle α is equal to 0°. In this case, the sipes 11 are said to be circumferential sipes.

In another example, illustrated in FIG. 5, the sipes 11 form an angle α substantially equal to 45° with the circumferential direction D_{C} of the tyre 1.

In the above description, reference is made to a sidewall 6 having a single set 10 of sipes 11. However, it is possible to have a sidewall 6 comprising several sets of sipes that are substantially parallel.

It will be understood here that the teaching presented in this document with reference to the first set 10 of sipes 11 is applicable in the same way to any other sets of longitudinal sipes provided in the sidewall 6 of the tyre 1.

Thus, according to the example illustrated in FIG. 6, the sidewall 6 comprises a second set 20 of sipes 21 that complement the first set 10 of sipes 11.

Preferably, the sipes 21 of the second set 20 likewise extend generally in a longitudinal direction D_{L}′ and form a non-zero angle β with the longitudinal direction D_{L} of the sipes 11 of the first set 10.

The angle β is for example between 70° and 120°, preferably between 80° and 110°, and more preferably around 90°.

The tyres generally have a certain number of markings on the sidewalls, notably markings that protrude from the external surface of the tyre sidewall. These marking may for example relate to the brand of tyre, the logo, the size, etc.

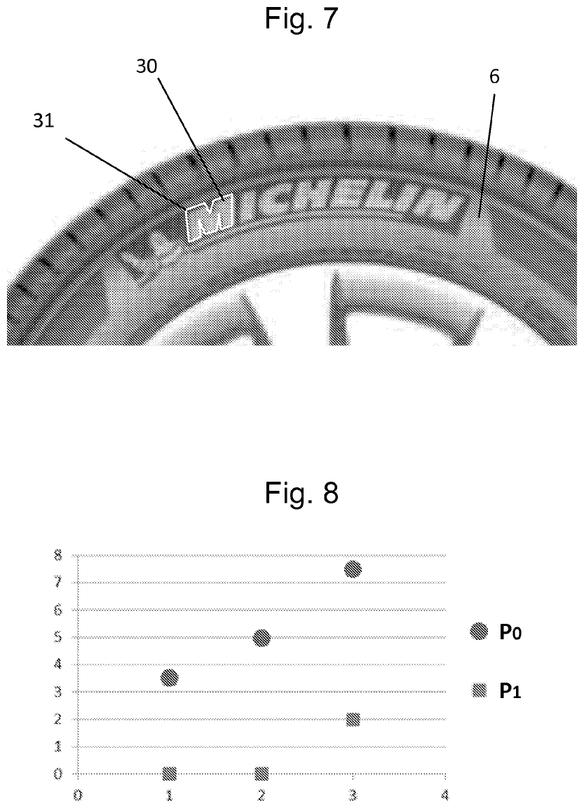

According to an example illustrated in FIG. 7, the sidewall 6 of the tyre 1 comprises at least one complementary sipe 31 delimiting a protruding portion 30 forming the marking. More specifically, in the example in FIG. 7, the sipe surrounds the letter “M” that is part of the marking in relief of the brand MICHELIN®.

This complementary sipe 31 is preferably formed at the corner edge between the protruding portion 30 and the surface of the sidewall 6, that is to say in the concave corner portion between the surface of the sidewall 6 and the marking.

This complementary sipe 31 preferably has a shape identical to that of the sipes 11 of the set 10, thereby making it possible to protect the tyre from chemical attack of the ozone type.

These different sipes provided in the sidewalls 6 and described above can be formed by a cutting process, notably cutting without removal of material.

FIG. 8 is a graph highlighting comparative tests for ozone wear between a standard tyre P0 and a tyre P1 having sidewalls in which sipes have been formed.

The tyre P0 is a standard reference tyre, i.e. the sidewalls do not comprise any sipe or cut.

The tyre P1 is identical to the tyre P0 but also comprises sipes formed in the sidewall 6, arranged in a circumferential configuration like the one illustrated in FIG. 4. Each sipe has a simple profile as per the model illustrated in FIG. 2, with a height H of 2 mm and a zero thickness e (e=0 mm). The sipes are formed by cutting without removal of material. The incisions are dense, formed at a spacing Ps of 2 mm.

For the comparative test, the tyres P0 and P1 each followed 3 cycles of exposure to ozone of one week.

The graph in FIG. 8 illustrates the level of ozone attack on a scale ranging from 0, corresponding to a lack of cracks, to 10, corresponding to the presence of large, dense cracks (with a size on the cm scale).

The results show a significant improvement in resistance to ozone attack for the tyre P1 compared with the reference tyre P0.

It should in particular be noted that there were absolutely no cracks during the first two weeks of exposure to ozone for the tyre P1, whereas the reference tyre P1 was very cracked, even after the first week.

1.-17. (canceled)

18. A tire for a rolling assembly comprising a rim and a tire, the tire having at least one carcass reinforcement surmounted radially on the outside by a crown reinforcement, itself radially on the inside of a tread having two axially outermost ends, the crown reinforcement being made up of at least one layer of reinforcing elements, the tread being connected to two beads by way of two sidewalls, the beads being intended to come into contact with a rim having rim flange tops, each bead having at least one circumferential reinforcing element,
wherein each sidewall comprises at least one set of sipes that are substantially parallel and spaced apart at a spacing having a value strictly less than 5 mm, each sipe being formed in the sidewall with a depth and a width, the depth having a value of between one quarter of the value of the spacing and the value of the spacing, and the width having a value strictly less than one quarter of the spacing.

19. The tire of claim 18, wherein each sipe has a depth having a value of between one third of the value of the spacing and seven tenths of the value of the spacing.

20. The tire of claim 18, wherein the spacing has a value strictly less than 3.5 mm.

21. The tire of claim 18, wherein each sipe has a width having a value strictly less than one tenth of the spacing.

22. The tire of claim 18, wherein each sipe has a width having a value strictly less than one tenth of a quarter of the spacing.

23. The tire of claim 18, wherein each sipe has a width having a value strictly less than 0.45 mm.

24. The tire of claim 18, wherein each sipe has a width having a value less than or equal to 0.3 mm.

25. The tire of claim 18, wherein each sipe has a cross-section having a straight portion of width and extending from the surface of the sidewall, and a circular portion extending from the straight portion, the circular portion having a radius having a value strictly greater than two thirds of the value of the width.

26. The tire of claim 18, wherein the sipes are arranged over the entire area of the sidewall.

27. The tire of claim 18, wherein the sipes are arranged in a region of the sidewall contained at least between a point A and a point C, where the point A is positioned at the junction between the sidewall and the tread, and the point C is positioned on the sidewall where the distance between the two sidewalls of the tire is greatest when the tire is inflated.

28. The tire of claim 18, wherein each sipe extends generally in a longitudinal direction.

29. The tire of claim 18, wherein the sipes are formed on the sidewall in a longitudinal direction so as to form an angle α of between 0° and 60° with the circumferential direction of the tire.

30. The tire of claim 18, wherein each sidewall comprises a second set of sipes, wherein the sipes of the second set form an angle β with the sipes of the set, the angle β being between 70° and 120°.

31. The tire of claim 30, wherein the sipes of the second set have a shape, relative arrangement, or both shape and relative arrangement identical to those of the sipes of the set.

32. The tire of claim 18, wherein the sidewall comprises at least one portion protruding with respect to the surface of the sidewall, the sidewall comprising at least one complementary sipe delimiting the protruding portion.

33. The tire of claim 32, wherein the at least one complementary sipe is formed at the corner edge between the protruding portion and the surface of the sidewall.

34. The tire of claim 32, wherein the at least one complementary sipe has a shape identical to that of the sipes of the set.

35. The tire of claim 18, wherein each sipe has a width having a value less than or equal to 0.2 mm.

36. The tire of claim 18, wherein the sipes are formed on the sidewall in a longitudinal direction so as to form an angle α equal to 45° with the circumferential direction of the tire.

37. The tire of claim 18, wherein each sidewall comprises a second set of sipes, wherein the sipes of the second set form an angle β with the sipes of the set, the angle β being between 80° and 110°.

38. The tire of claim 18, wherein each sidewall comprises a second set of sipes, wherein the sipes of the second set form an angle β with the sipes of the set, the angle β equal to 90°.
